(19) United States
(12) Patent Application Publication
(10) Pub. No.: US 2010/0294232 A1
(43) Pub. Date: Nov. 25, 2010

(54) INTERNAL COMBUSTION ENGINE

(76) Inventor: Lars Otterstrom, Orangeville (CA)

Correspondence Address: SIM & MCBURNEY, 330 UNIVERSITY AVENUE, 6TH FLOOR, TORONTO, ON, M5G 1R7, CA

(21) Appl. No.: 12/470,531

(22) Filed: May 22, 2009

(51) Int. Cl. F02B 75/32

(52) U.S. Cl. 123/197.1; 701/102

(57) ABSTRACT

A method for manipulating a piston within a cylinder of an internal combustion engine is described. The method comprises: sensing dynamic top dead centre (DTDC) and dynamic bottom dead centre (DBDC); and selectively engaging a first power transfer mechanism with the piston when DTDC is sensed and selectively disengaging the first power transfer mechanism from the piston when DBDC is sensed.

### FIELD OF THE INVENTION

The present application relates to internal combustion engines. More specifically, the present application relates to a system for transferring power between a piston and a main driveshaft of an internal combustion engine.

### BACKGROUND OF THE INVENTION

Internal combustion engines are well known and are in widespread use in several industries, most notably the automobile industry. A conventional internal combustion engine employs at least one piston reciprocating within a cylinder and operably connected to a crankshaft. Ignition of fuel (such as atomized gasoline) within the combustion chamber or the cylinder forces the piston along the cylinder which, in turn, forces the crankshaft to turn. The crankshaft transmits rotational force to the main driveshaft providing operating power for use by the machine incorporating the engine.

A free piston engine is a linear “crankless” internal combustion engine in which the piston motion is not controlled by a crankshaft but instead is determined by the interaction of forces from the combustion chamber gases, a rebound device (e.g. a piston in a closed cylinder) and a load device (e.g. a gas compressor or a linear alternator).

While several well-known engine configurations exist that employ spark ignition to control the timing of combustion, other configurations employ compression ignition. Compression ignition is caused when the conditions within the combustion chamber are such that the fuel is caused to “spontaneously” ignite under pressure. One such type of compression ignition is homogeneous charge compression ignition (“HCCI”). An HCCI-operated internal combustion engine is more efficient and also has lower nitrogen oxide (“NOx”) emissions than a conventional spark ignition-operated internal combustion engine. A free piston engine is well-suited to HCCI since it has a more relaxed ignition timing requirement due to the lack of a crankshaft.

Many alternatives to conventional internal combustion engines have been considered and are described in the following references, each of which is incorporated herein by reference in its entirety: U.S. Pat. No. 4,363,299 to Bristol; U.S. Pat. No. 4,395,977 to Pahis; U.S. Pat. No. 4,567,866; U.S. Pat. No. 4,608,951 to White; U.S. Pat. No. 4,803,890 to Giuliani et al.; U.S. Pat. No. 5,056,475 to Park; U.S. Pat. Nos. 5,094,202 and 5,406,859 to Belford; U.S. Pat. No. 5,755,195 to Dawson; U.S. Pat. No. 5,992,356 to Howell-Smith; U.S. Pat. No. 6,722,127 to Scuderi et al.; U.S. Pat. No. 6,792,924 to Aoyama et al.; U.S. Pat. No. 6,827,058 to Falero; U.S. Pat. No. 7,475,666 to Heimbecker; U.S. Publication No. 2002/0185101 to Shaw; U.S. Publication No. 2007/0295122 to Garavello; Johansson, B., “Homogeneous Charge Compression Ignition—the Future of IC engines?”, International Journal of Vehicle Design, Vol. 44, 2007; Van Blarigan, P. et al., “Homogeneous Charge Compression Ignitions with a Free Piston: A New Approach to Ideal Otto Cycle Performance”, SAE Technical Paper Series 982484, 1998; Mikalsen, R. and Roskilly, A. P., “A computational study of free-piston diesel engine combustion”, Jun. 24, 2008; U.S. Department of Energy, “Homogeneous Charge Compression Ignition (HCCI) Technology: A Report to the U.S. Congress”, April 2001; and Christensen et al., “Homogeneous Charge Compression Ignition (HCCI) Using Isooctane, Ethanol and Natural Gas—A Comparison with Spark Ignition Operation”, SAE Technical Paper Series 972874, October 1997.

Although effective internal combustion engines exist, improvements are desired. It is therefore an object of an aspect of the following to provide a novel system for transferring power between a piston and a main driveshaft of an internal combustion engine.

### SUMMARY OF THE INVENTION

In accordance with an aspect, there is provided a method for manipulating a piston within a cylinder of an internal combustion engine, the method comprising: sensing dynamic top dead centre (DTDC) and dynamic bottom dead centre (DBDC); and selectively engaging a first power transfer mechanism with the piston when DTDC is sensed and selectively disengaging the first power transfer mechanism from the piston when DBDC is sensed.

In accordance with another aspect, there is provided a method for operating a four stroke internal combustion engine, wherein the engine comprises a cylinder with a cylinder head, a piston, a pushrod, means for actuating the pushrod, a gear releasably coupled to a secondary driveshaft, and a transmission, the method comprising initiating intake stroke by actuating the pushrod downward, the cylinder taking in fuel during the intake stroke; initiating compression stroke by actuating the pushrod upward, the piston compressing the fuel in the cylinder during the compression stroke; initiating the expansion power stroke by igniting the fuel and engaging the gear with the secondary driveshaft, wherein the igniting causes the piston and pushrod to move downward and rotate the gear and secondary driveshaft, transmitting the energy generated during the expansion power stroke to the main engine driveshaft; and initiating the exhaust stroke by actuating the pushrod upward, the cylinder releasing exhaust during the exhaust stroke.

In accordance with another aspect, there is provided a system for transferring power between a piston and a main driveshaft of an internal combustion engine comprising: an ignition detector detecting compression ignition of combustible fuel in a combustion chamber associated with the piston; and a selectively engagable first power transfer mechanism responsive to detection of ignition by the ignition detector to engage thereby to transfer power from the piston to the main driveshaft for a power stroke.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### BRIEF DESCRIPTION OF THE DRAWINGS

Embodiments will now be described with reference to the accompanying drawings in which:

FIG. 1 is front cross-sectional view of one embodiment of an internal combustion engine.

FIG. 2 is a side elevation view of the internal combustion engine shown in FIG. 1.

FIG. 3 is another side elevation view of the internal combustion engine shown in FIG. 1.

FIG. 4 is a front cross-sectional view of driveshafts connected to the internal combustion engine shown in FIG. 1.

FIG. 5 is a side elevation view of driveshafts shown in FIG. 4.

FIG. 6 is a perspective view of the internal combustion engine shown in FIG. 1, during the intake stroke of the Otto cycle.

FIG. 7 is a perspective view of the internal combustion engine shown in FIG. 1, during the compression stroke of the Otto cycle.

FIG. 8 is a perspective view of the internal combustion engine shown in FIG. 1, during the expansion power stroke of the Otto cycle.

FIG. 9 is a perspective view of the internal combustion engine shown in FIG. 1, during the exhaust stroke of the Otto cycle.

FIG. 10 is partial front cross-sectional view of another embodiment of an internal combustion engine.

FIG. 11 is a schematic diagram of a hydraulic system for use with the internal combustion engine shown in FIG. 10.

FIG. 12 is a perspective view of the internal combustion engine shown in FIG. 10.

FIG. 13 is front cross-sectional view of another embodiment of an internal combustion engine.

FIG. 14 is a side elevation view of the internal combustion engine shown in FIG. 13.

FIG. 15 is a perspective view of the internal combustion engine shown in FIG. 13.

FIG. 16 is front cross-sectional view of another embodiment of an internal combustion engine.

### DETAILED DESCRIPTION OF THE EMBODIMENTS

A system, an internal combustion engine, and a method are disclosed herein. The system disclosed herein enables control of the operation of an internal combustion engine by manipulating piston movement and positioning within a cylinder independently of the rotational position of the engine's main driveshaft. A selectively modifiable connection between the piston and the driveshaft, under control of an engine management system, is maintained for the transmission of energy to the piston for the intake, compression and exhaust strokes of the well-known Otto cycle, and for the transmission of energy from the piston to the driveshaft for the expansion, or “power” stroke. The piston is engaged to and disengaged from the engine driveshaft in such a way as to allow the piston to be stopped at any desired point of its down stroke travel during the intake stroke allowing for a virtually unlimited variable compression to expansion ratio. The system and method also allow for the piston to change direction from its up stroke during compression to its expansion down stroke, regardless of where in the cylinder the piston is positioned at the time compression ignition occurs. Because change of direction is responsive to ignition it is relatively unconstrained when compared with prior art engines in its ability to operate in HCCI-mode over a wide range of load and operational conditions.

Unless otherwise indicated, the following terms as used herein are defined as follows:

The direction “up” as used herein signifies piston movement towards the cylinder head. The direction “down” as used herein signifies piston movement away from the cylinder head.

“Absolute top dead centre” (“ATDC”) as used herein is the position physically closest to the cylinder head to which the piston can travel and is analogous to the “top dead centre” (“TDC”) in a traditional crankshaft- and pushrod-equipped internal combustion engine. It is the point in the engine cycle where the piston is the closest to the head of the cylinder, such that the volume made up of the cylinder wall, cylinder head, and piston is the smallest.

“Dynamic top dead centre” (“DTDC”) as used herein is the physical position of the piston at the time of ignition and is analogous to the TDC in a traditional free piston internal combustion engine.

“Absolute bottom dead centre” (“ABDC”) as used herein is the position farthest away from the cylinder head to which the piston can travel and is analogous to “bottom dead centre” (“BDC”) in a traditional crankshaft- and pushrod-equipped internal combustion engine. It is the point in the engine cycle where the piston is farthest away from the head of the cylinder, such that the volume made up of the cylinder wall, cylinder head, and piston is the greatest.

“Dynamic bottom dead centre” (“DBDC”) as used herein is the physical position of the piston at the time it is stopped during the adjustable intake stroke.

An embodiment of the internal combustion engine will now be described with reference to the figures.

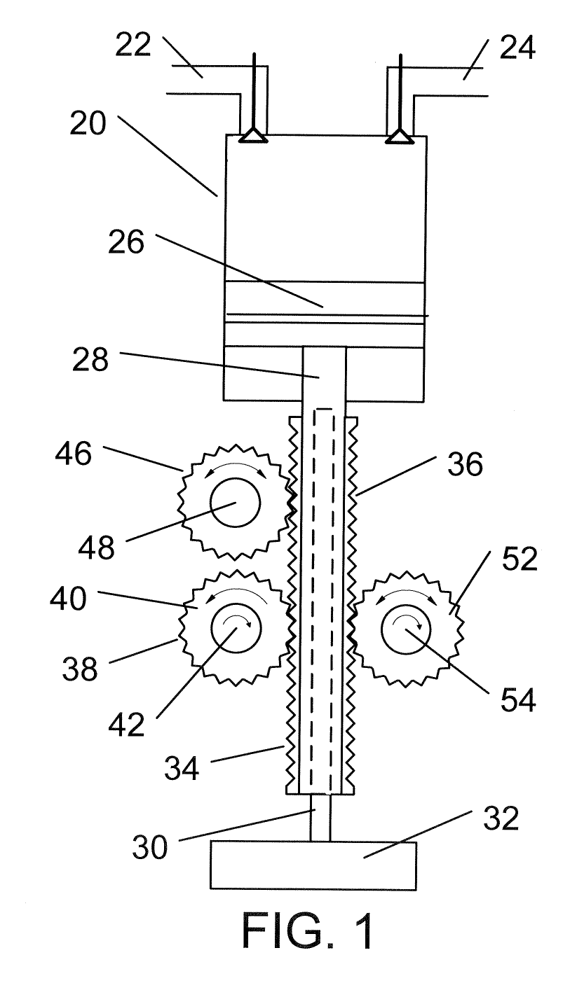

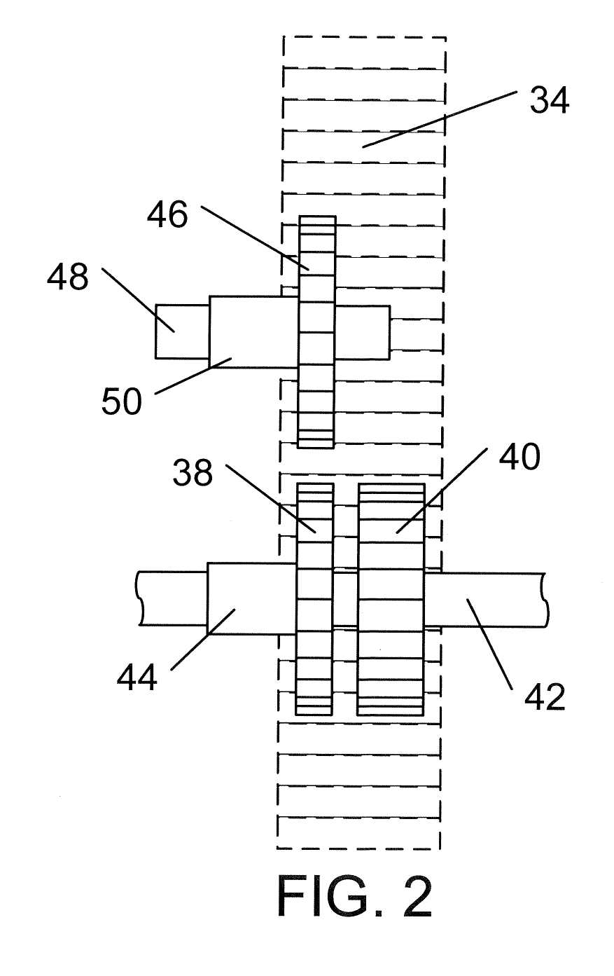

FIG. 1 shows a cylinder 20 of an internal combustion engine. The cylinder 20 has an intake port and intake valve 22 and an exhaust port and exhaust valve 24. A piston 26 is slidably disposed within the cylinder 20. In this embodiment, the piston 26 is connected to a hollow pushrod 28, which slides up and down along a rod guide 30. When the piston 26 moves up and down the pushrod 28 moves with it and is ensured of a linear path from ATDC all the way to ABDC. More particularly, the rod guide 30 is fastened to the engine block 32 so as to ensure that the piston 26 is aligned in a parallel relationship with the walls of the cylinder 20 at all times while the piston 26 travels up and down within the cylinder 20. First gear rack 34 and second gear rack 36 are attached to the pushrod 28, on generally opposing sides of the pushrod 28. The first gear rack 34 engages a first freewheeling gearwheel 38 and, as is shown in FIG. 2, a counterclockwise overrunning clutch 40. It will be evident that the counterclockwise overrunning clutch 40 is an optional feature.

Referring now to FIGS. 1 and 2, the first freewheeling gearwheel 38 and the counterclockwise overrunning clutch 40 are mounted in tandem around a secondary driveshaft 42. The first freewheeling gearwheel 38 freely rotates about the secondary driveshaft 42 in both clockwise and counterclockwise directions. The first freewheeling gearwheel 38 is connected to the secondary driveshaft 42 by a fast-acting clutch 44.

The counterclockwise overrunning clutch 40 is mounted around the secondary driveshaft 42 such that clutch 40 engages the secondary driveshaft 42 if clutch 40 is rotating clockwise at a faster velocity than the secondary driveshaft 42 is rotating. Clutch 40 also disengages from the secondary driveshaft 42 if clutch 40 is rotating clockwise at a slower velocity than the secondary driveshaft 42 is rotating. In other words, the counterclockwise overrunning clutch 40 is mechanically constructed to automatically engage with the secondary driveshaft 42 whenever its clockwise rotational speed is higher than the clockwise rotational speed of the secondary driveshaft 42.

The first gear rack 34 also engages a gearwheel 46, which is mounted around a fixed short axle 48 for free rotation in the clockwise and counterclockwise directions. The gearwheel 46 is connected to the axle 48 by a clutch/brake assembly 50, which, when activated, prevents gearwheel 46 from rotating, thus holding pushrod 28 and piston 26 in the desired stoppage position during cylinder shut-down.

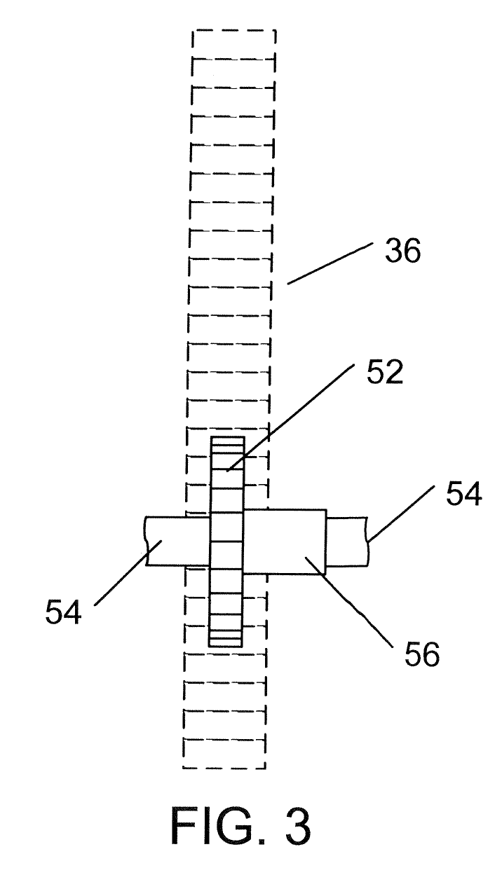

Referring now to FIGS. 1 and 3, the second gear rack 36 engages a second freewheeling gearwheel 52, which is mounted around a secondary driveshaft 54 for free clockwise and counterclockwise rotation around the secondary driveshaft 54. The second freewheeling gearwheel 52 is rotationally connected to the secondary driveshaft 54 by a fast acting clutch 56. The fast-acting clutch 44 will engage and hold the first freewheeling gearwheel 38 in rotational lock with the secondary driveshaft 42 during the expansion power stroke of piston 26 with little, if any, slippage. Together, and as will be more fully explained below, the fast-acting clutches 44 and 56 and the first and second freewheeling gearwheels 38 and 52, function as means for actuating the pushrod 28 and transferring power therefrom to the main driveshaft 58.

Fast-acting clutches 44 and 56 are of the “Magnetic Particle Clutch” type, providing fast response time and operation in limited slip mode without mechanical wear.

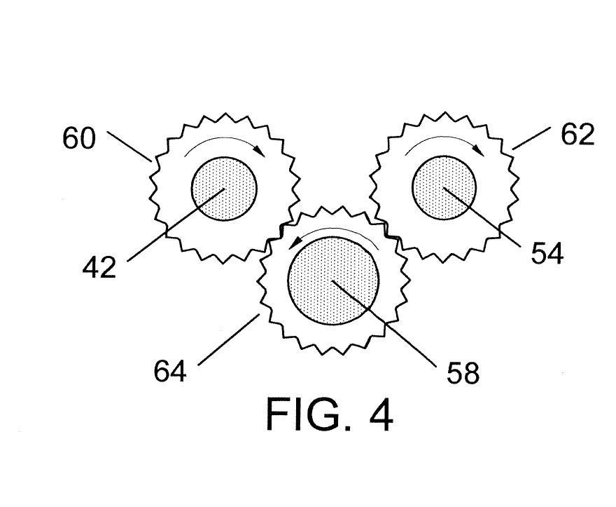

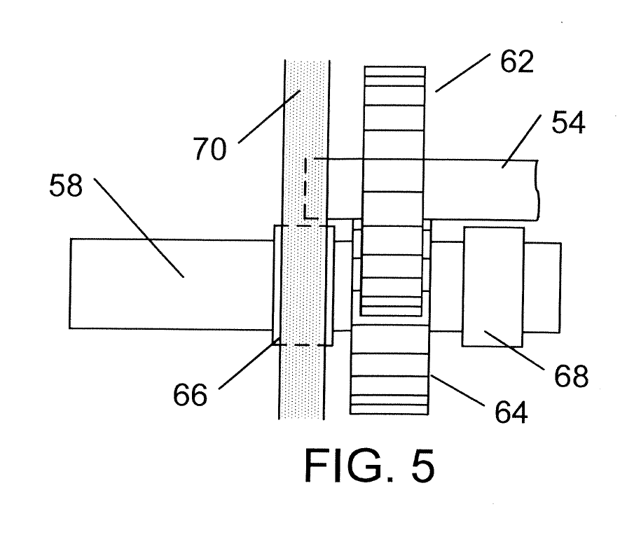

Referring now to FIG. 4, the main engine driveshaft 58 is shown. The secondary driveshafts 42 and 54 are engaged with the main engine driveshaft 58 through gearwheels 60, 62, and 64, so that both secondary driveshafts 42 and 54 maintain clockwise rotation when the engine is running. Gearing ratios between the gearwheels 60, 62, and 64 determine the piston 26 up stroke and down stroke speed relative to one another as well as piston 26 cycle duration relative to the rotational speed of the main engine driveshaft 58. FIG. 5 shows the main engine driveshaft 58, mounted in bearings 66 and 68, penetrating the engine housing 70.

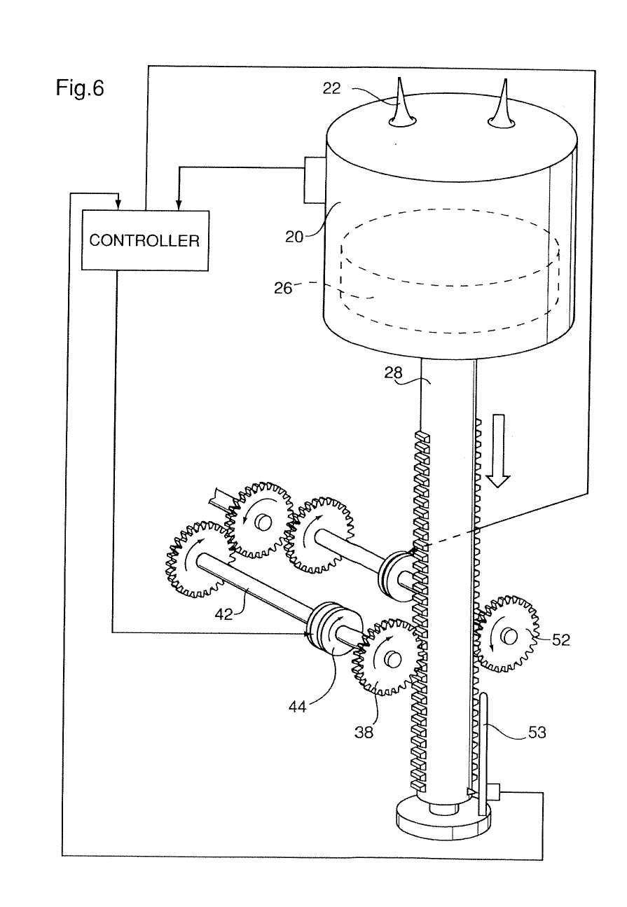

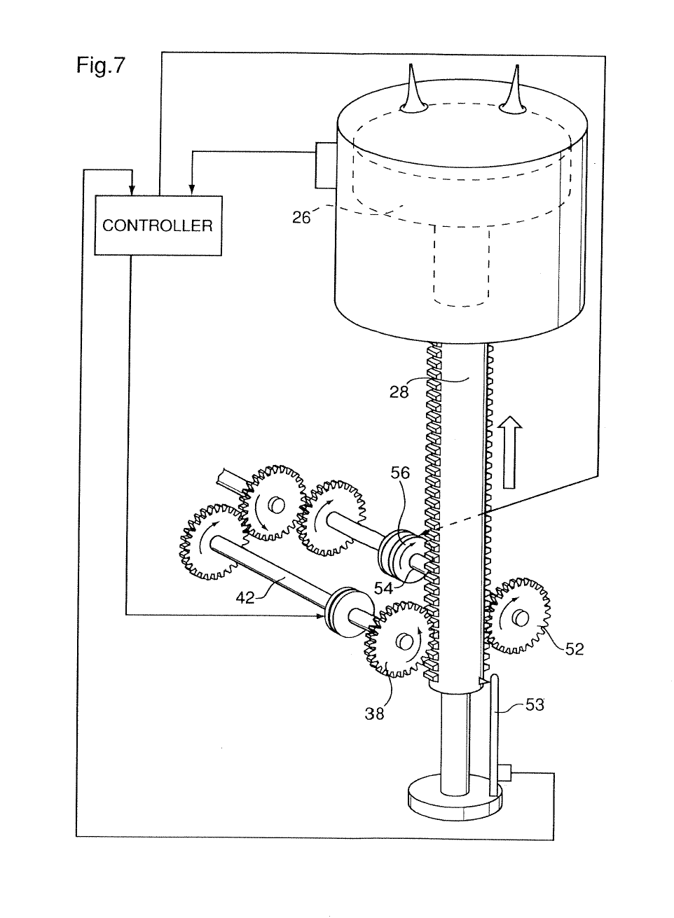

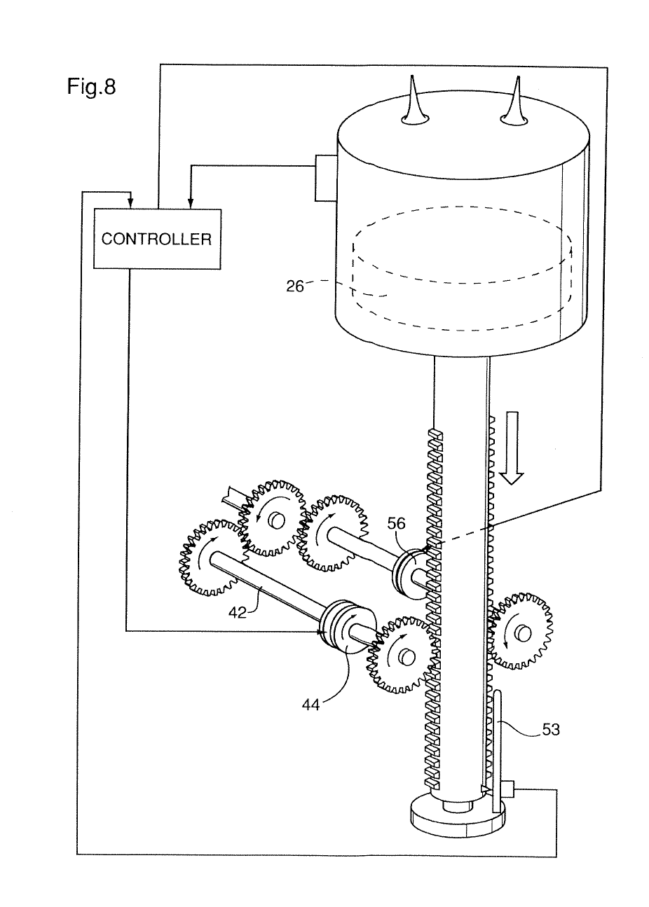

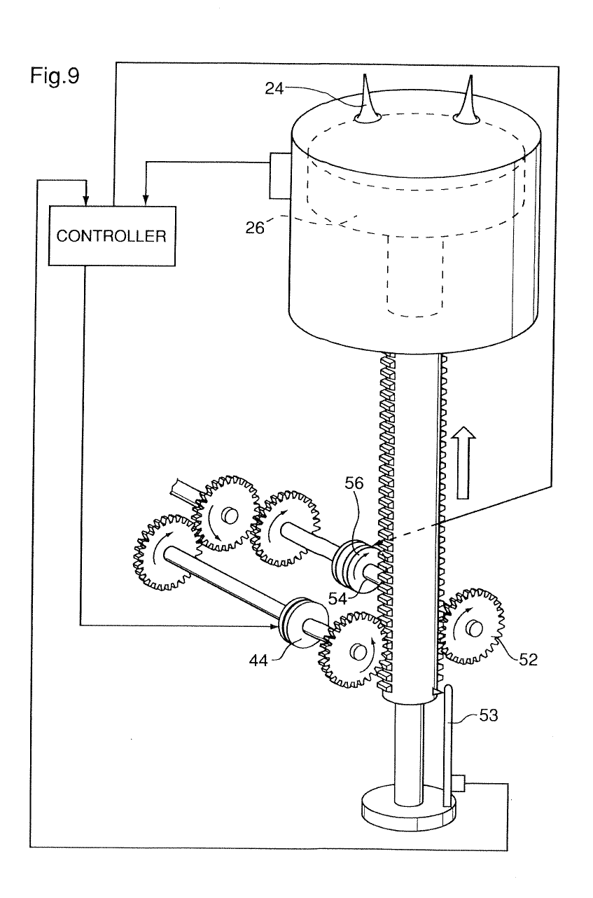

In use, the internal combustion engine described herein undergoes the four strokes of the standard Otto cycle, as is shown in FIGS. 6, 7, 8, and 9. The counterclockwise overrunning clutch 40, the gearwheel 46, axle 48, and clutch/brake assembly 50 are optional features and thus, for ease of understanding, are not shown in these figures. Going through a complete four stroke cycle and starting at ATDC, a computerized engine management system (“EMS”), which receives inputs from sensors monitoring the engine's operating condition, load demands, ignition piston position, and operator inputs, initiates the intake stroke (FIG. 6) by activating the fast-acting clutch 44. This in turn rotationally engages the first freewheeling gearwheel 38 with the secondary driveshaft 42, resulting in a downward movement of the pushrod 28 and the piston 26. As the piston 26 and the pushrod 28 travel downward, the first freewheeling gearwheel 38 rotates clockwise, while the second freewheeling gearwheel 52 rotates counterclockwise. As soon as physical clearance allows, the EMS opens the intake valve 22 by means of hydraulic pressure or electric power, allowing the mixture of fuel and air to enter the combustion chamber of the cylinder 20. When DBDC is reached (a position determined by the EMS under consideration of the engine operating conditions and load demands on the engine), the EMS closes the intake valve 22 and deactivates the fast-acting clutch 44. The fast-acting clutch 44, in turn, rotationally disengages the first freewheeling gearwheel 38 from the secondary driveshaft 42, ending the intake stroke.

With the intake stroke having ended, the EMS then initiates the compression stroke by activating the fast-acting clutch 56, which rotationally engages the second freewheeling gearwheel 52 with the secondary driveshaft 54. As the secondary driveshaft 54 turns, the pushrod 28 and the piston 26 are moved upwards, thus compressing the fuel and air mixture in the combustion chamber. As the piston 26 and the pushrod 28 continue to move upward, the first freewheeling gearwheel 38 rotates in a counterclockwise direction but is disengaged from the secondary driveshaft 42. Meanwhile, the second freewheeling gearwheel 52 rotates in a clockwise direction. The upward movement of the piston 26 continues until compression ignition occurs, at which point DTDC has been reached, ending the compression stroke.

As DTDC is reached upon compression ignition, an ignition sensor is employed to sense ignition in the combustion chamber and accordingly signal the EMS to initiate the expansion, or “power” stroke. At this point, the EMS deactivates the fast-acting clutch 56 and activates the fast-acting clutch 44. The fast-acting clutch 44 engages and holds the first freewheeling gearwheel 38 in rotational lock with the secondary driveshaft 42 during the power stroke of piston 26 without slippage. As the piston 26 is forced downward by the expanding gases, the energy released by ignition is thus transferred via the piston 26 and piston rod 28 to the secondary driveshaft 42 by fast-acting clutch 44. The piston 26 continues its downward movement until ABDC is reached, at which point the power stroke is ended.

A position sensor 53 detects that the piston 26 is at ABDC, and signals the EMS to begin the exhaust stroke. In response, the EMS opens up the exhaust valve 24 by means of hydraulic pressure or electric power. The EMS also deactivates the fast-acting clutch 44, and activates the fast-acting clutch 56, which, in turn, engages the second freewheeling gearwheel 52 with the secondary driveshaft 54, pushing the piston 26 upwards. The EMS ensures that the exhaust valve 24 is closed as the piston 26 approaches ATDC in order to ensure physical clearance between the piston 26 and the exhaust valve 24. As ATDC is reached, the EMS deactivates fast-acting clutch 56, thus completing the exhaust stroke. The above-described implementation of the Otto cycle is repeated continuously as the engine is operated.

It will be readily apparent that, under the control of the EMS, the piston 26 is selectively engaged to and disengaged from the main engine driveshaft 58 for different purposes. The piston 26 is thereby able to be stopped at any desired point during its down stroke travel during the intake stroke, thus enabling a wide range of compression to expansion ratios. The piston 26 is also thereby able to change direction from its up stroke during compression to its down stroke during expansion, regardless of where in the cylinder the piston is positioned at the time of ignition, thus providing a solution for overcoming the major constraint to operating internal combustion engines in HCCI-mode over a wide range of load and operational conditions.

It will also be appreciated that in multi-cylinder engines containing the invention described herein, there is no absolute fixed relationship between piston positions from cylinder to cylinder, due to cylinder to cylinder variations in DTDC. Thus, the EMS is responsible for maintaining control of the cycle start times in each cylinder 20 to ensure that power is smoothly being transferred to the main engine driveshaft 58. To this end, in this embodiment the gearwheel 46, axle 48, and clutch/brake assembly 50 are controlled by the EMS to hold a given piston at ATDC and thereby retard its cycle start time in order to control engine vibration. When cycle retardation is required, the EMS activates the clutch/brake assembly 50 for the duration of the required retardation time and disengages the fast-acting clutches 44 and 56. Further, it deactivates the clutch/brake assembly 50 and activates the fast-acting clutch 44 to initiate the piston cycle. As an additional advantage, given that the piston 26 can in effect be decoupled from the main engine driveshaft 58 at any position in the cycle (but preferably at ATDC) this mechanism can also be used to shut down individual cylinders 20 or to reduce the number of engine/piston cycles per revolution of the main engine driveshaft 58 by controlling cycle retardation time. This can be useful for reducing fuel consumption under light engine load, for example.

The fast-acting clutch 44 has been described above as engaging and holding the first freewheeling gearwheel 38 in rotational lock with the secondary driveshaft 42 during the expansion power stroke of piston 26 without slippage, and preferably as being of the “Magnetic Particle Clutch” type. However, it will be understood that the fast-acting clutch 44 could optionally act as a continuous slip-clutch for the high pressure sustained during the initial part of the expansion stroke so as to dampen the impact of the rotational engagement of the counterclockwise overrunning clutch 40 with the secondary driveshaft 42 and the resulting brake in downward piston 26 speed. It will also be understood that the counterclockwise overrunning clutch 40 is optional and is only required if the fast-acting clutch 44 does not sliplessly engage the first freewheeling gearwheel 38 to the secondary driveshaft 42 during the expansion power stroke of the piston 26.

In embodiments previously described, the gearwheel 46, axle 48, and clutch/brake assembly 50 held the pushrod 28 and piston 26 in the desired stoppage position during cylinder shut-down. It will be understood that alternatives are provided for holding the pushrod 28 and piston 26 in the desired stoppage position during cylinder shut-down and that, in fact, configurations may not include the gearwheel 46, axle 48, and clutch/brake assembly 50, depending upon the chosen implementation.

The fast-acting clutches 44 and 56 and the first and second freewheeling gearwheels 38 and 52 have been described above as acting together as a means for actuating the pushrod 28. However, other means for actuating the pushrod 28 are also contemplated, such as an electric motor or a hydraulic system.

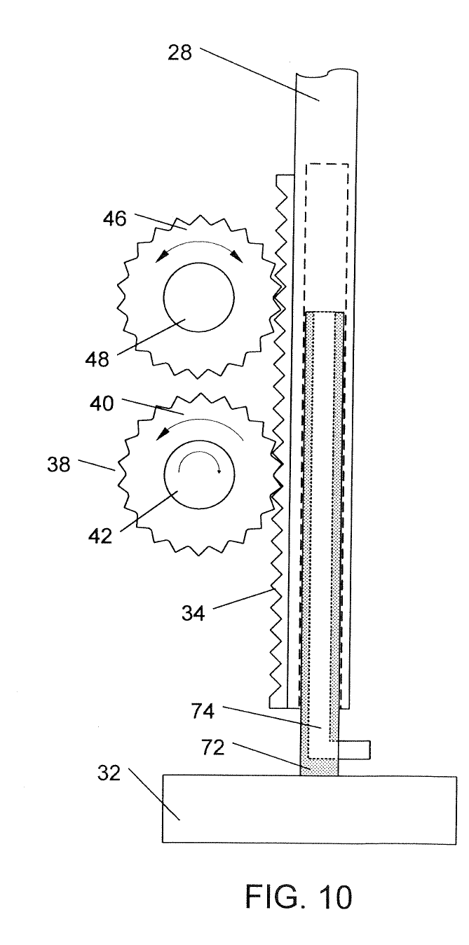

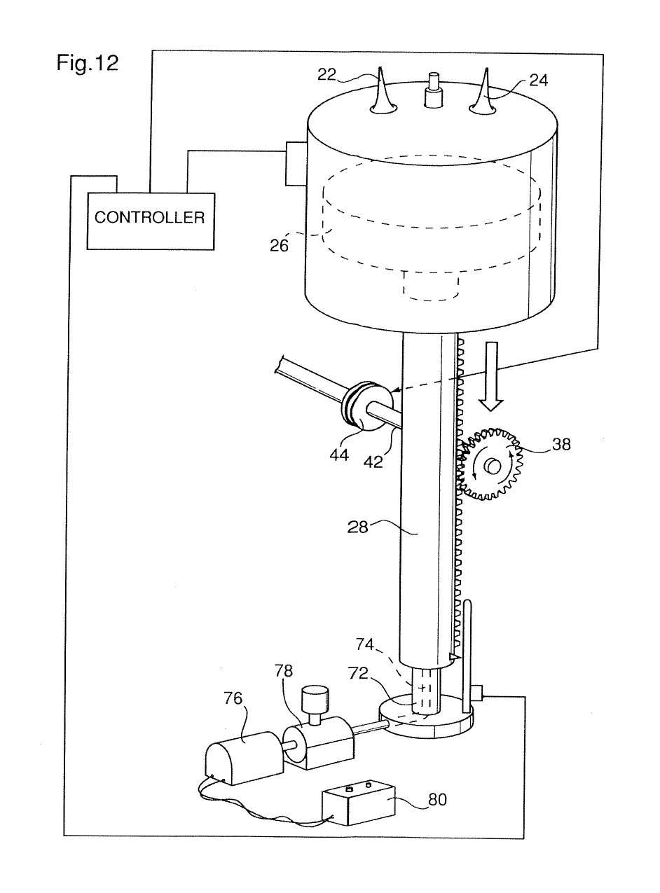

An embodiment of a hydraulic system for activating the pushrod 28 as described above is shown in FIGS. 10, 11, and 12. In this embodiment, the pushrod 28 is slidably mounted on a hollow rod guide 72. The rod guide 72 has a hydraulic fluid channel 74 through which hydraulic fluid can enter. When hydraulic fluid, under pressure, enters the channel 74, it pushes the pushrod 28 and the attached piston 26 away from the rod guide 72 and towards the head of the cylinder 20, thus initiating upward motion of the pushrod 28 and piston 26. As has been described above in reference to FIG. 1, it will be evident that the rod guide 72 is fastened to the engine block 32 so as to ensure that the piston 26 is aligned in parallel orientation with the walls of the cylinder 20 at all times when the piston 26 is traveling up and down within the cylinder 20. It will also be evident that in this embodiment, the second gear rack 36 and the accompanying second freewheeling gearwheel and secondary driveshaft 54 are not required because the hydraulic system activates the pushrod 28.

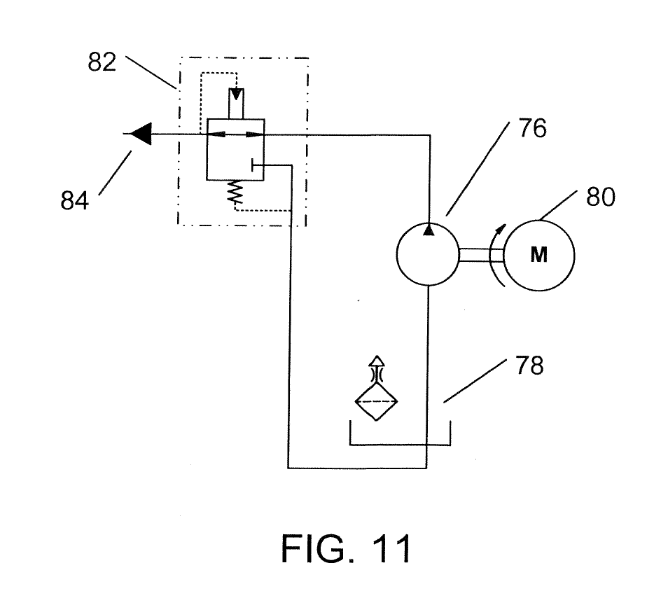

Referring now to FIG. 11, there is shown a schematic diagram of a hydraulic fluid subsystem that is used to control the actuation of the piston 26. A hydraulic pump 76 pumps fluid from a reservoir 78 and is driven by an electric motor 80. The hydraulic pump 76 is capable of delivering a sufficient volume of hydraulic fluid to the channel 74 of the pushrod 28 at a sufficiently high pressure in order to complete the engine compression stroke. Valve 82 is a shuttle valve with two stable states and is under the control of the EMS. In an HCCI-operated engine, it is also under the control of valve port 84. The valve port 84 has a pressure sensor that is set to initiate switchback when the pressure sensed is higher than the highest pressure required within the cylinder 20 in order to obtain compression ignition.

Going through a complete four stroke cycle and beginning at ATDC, the intake stroke starts when the EMS activates the fast-acting clutch 44, which in turn rotationally engages the first freewheeling gearwheel 38 to the secondary drive shaft 42, resulting in downward movement of the pushrod 28 and the piston 26. As soon as physical clearance allows, the EMS opens the intake valve 22, by means of hydraulic pressure (by a different or auxiliary subsystem) or electric power. When DBDC is reached, the EMS closes the intake valve 22, and deactivates the fast-acting clutch 44. In turn, the fast-acting clutch 44 disengages the first freewheeling gearwheel 38 from the secondary driveshaft 42, ending the intake stroke.

With the intake stroke having ended, the EMS then activates the valve 82 of the hydraulic fluid subsystem, thus allowing hydraulic fluid to flow under sufficient pressure from the hydraulic pump 76 and through the valve 82, the valve port 84, and the channel 74 into a cavity made up of the rod guide 72 and the piston 26. The flow of pressurized hydraulic fluid causes the piston 26 to be forced upward thus starting the compression stroke. This upward movement continues until DTDC is reached due to ignition, at which point the compression stroke is ended. It will be understood that DTDC is determined by the EMS directly in an engine running in spark ignition mode. Alternatively, the increased pressure generated by the ignited charge may be sensed by the valve 82 in an engine running in HCCI-mode, which can in response signal the EMS.

The power stroke begins when ignition occurs. At this point, the EMS signals the valve 82 to release thereby to allow the hydraulic fluid within the channel 74 to return to the reservoir 78. The expansion of gases in the combustion chamber causes downward movement of the piston and rotational engagement of the counterclockwise overrunning clutch 40 with the clockwise-rotating secondary driveshaft 42. Hydraulic fluid flow resistance will serve to advantageously dampen the impact of this rotational engagement and the resulting brake in downward piston 26 speed. Thus, as the piston is forced downward by the expanding gases, the energy released by the ignited charge is transferred to the secondary driveshaft 42. The piston 26 continues its downward movement until ABDC is reached, ending the power stroke.

With the power stroke having ended, the EMS opens up the exhaust valve 24, by means of hydraulic pressure or electric power, and activates the valve 82. This allows fluid to flow into the channel 74, forcing the piston 26 upwards and starting the exhaust stroke. As required, in order to provide physical clearance between the piston 26 and the exhaust valve 24, the valve 24 may be closed as the piston 26 approaches ATDC. When ATDC is reached, the EMS deactivates the valve 82, thus completing the exhaust stroke and all four strokes of the standard Otto Cycle.

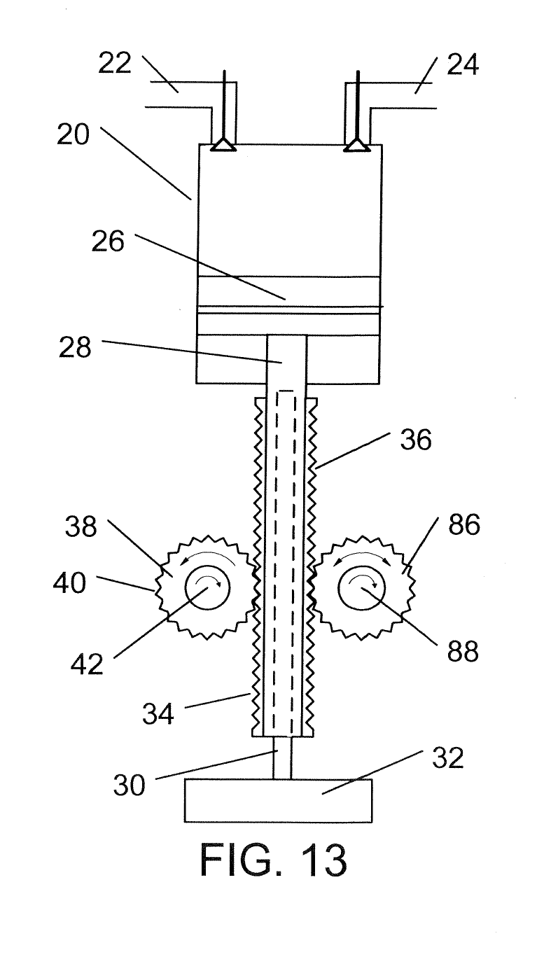

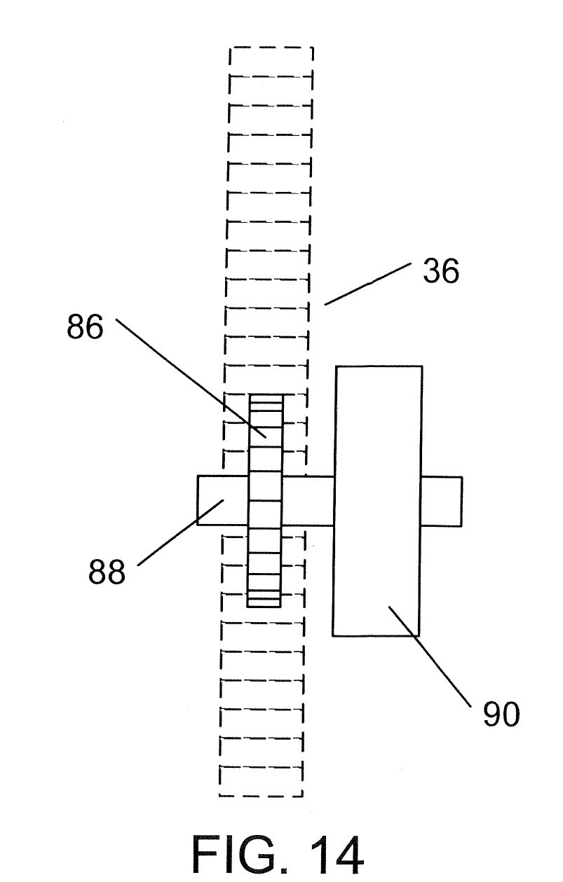

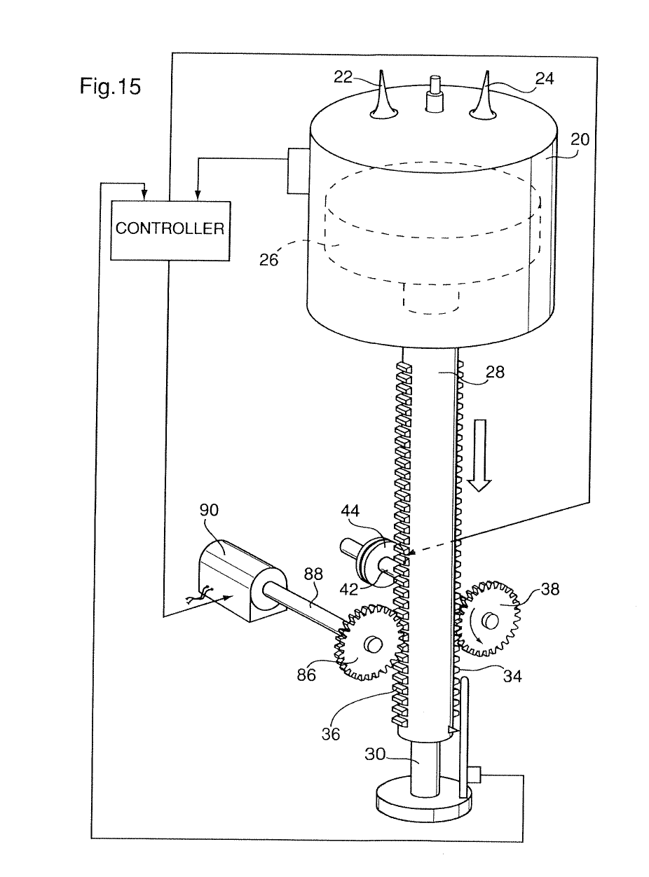

A reversible rotational electric motor subsystem for linearly moving the pushrod 28 may alternatively be used. Such a system is shown in part in FIGS. 13, 14, and 15. As has been described above in reference to FIG. 1, the internal combustion engine has a cylinder 20, a piston 26, a pushrod 28, and a guide rod 30. First and second gear racks 34 and 36 are mounted on opposing sides of pushrod 28. The gear rack 34 is engaged with the first freewheeling gearwheel 38 and the counterclockwise overrunning clutch 40. The first freewheeling gearwheel 38 and the counterclockwise overrunning clutch 40 are both mounted on the secondary driveshaft 42 as has been described above. The second gear rack 36 is engaged with a gearwheel 86, which is mounted on a short axle 88. In this embodiment, the axle 88 is fixed to and driven by a reversible electric motor 90. It will be evident that in this embodiment, the gearwheel 46 and axle 48 and the second freewheeling gearwheel 52 and secondary driveshaft 54 are not required.

Going through a complete four stroke cycle and beginning at ATDC, the intake stroke starts when the EMS activates the motor 90, rotating axle 88 and gearwheel 86 counterclockwise, resulting in a downward movement of the pushrod 28 and the piston 26. As soon as physical clearance allows, the EMS opens the intake valve 22, by means of hydraulic pressure or electric power. When DBDC is reached, the EMS closes the intake valve 22, ending the intake stroke.

With the intake stroke having ended, the EMS then changes the rotational direction of the motor 90 to clockwise rotation, resulting in an upward movement of the pushrod 28 and piston 26, starting the compression stroke. This upward movement continues until DTDC is reached, thus ending the compression stroke. DTDC is determined by the EMS directly in an engine running in spark ignition mode or by the EMS sensing ignition through a cylinder-mounted pressure transducer in an engine running in HCCI-mode.

The power stroke begins when ignition occurs. When the EMS senses (or causes) ignition, the EMS deactivates motor 90, allowing motor 90 to free-wheel. The EMS also activates fast-acting clutch 44, which engages and holds the first freewheeling gearwheel 38 in rotational lock with the secondary driveshaft 42 during the power stroke of the piston 26. Thus, as the piston is forced downward by the expanding gases, the energy released by the ignited charge is transferred to the secondary driveshaft 42 by the fast-acting clutch 44, by the counterclockwise overrunning clutch 40, or both. The piston 26 continues its downward movement until ABDC is reached, ending the power stroke.

At this time, the EMS opens up the exhaust valve 24, by means of hydraulic pressure or electric power, and deactivates the fast-acting clutch 44. The EMS also activates the motor 90 to cause rotation of the axle 88 in the clockwise direction, forcing the piston 26 upwards and starting the exhaust stroke. As required, in order to provide physical clearance between the piston 26 and the exhaust valve 24, the valve 24 may be closed as the piston 26 approaches ATDC. When ATDC is reached, the EMS deactivates the motor 90 or optionally reduces electric power to a level which will hold piston 26 at rest at ATDC, thus completing the exhaust stroke and all four strokes of the standard Otto Cycle.

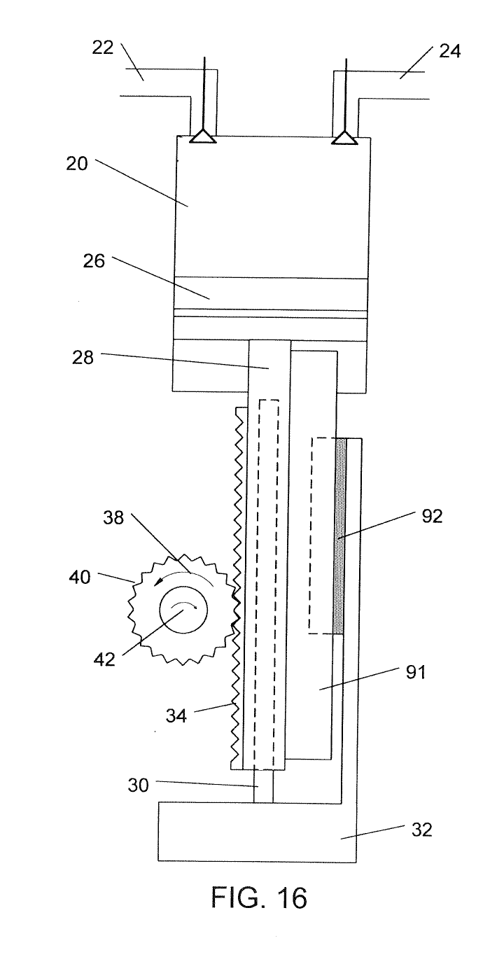

Other embodiments of the invention are contemplated herein. An embodiment of a reversible linear electric motor system consisting of magnetic track 91 and forcer 92 for use with the internal combustion engine described above is shown in FIG. 16. As has been described above in reference to FIG. 1, the internal combustion engine has a cylinder 20, a piston 26, a pushrod 28, and a guide rod 30. Gear rack 34 and magnetic track 91 are mounted on opposing sides of pushrod 28. Forcer 92 is fastened to the engine block 32 so as to ensure that magnetic track 91 and forcer 92 are aligned in a parallel relationship with each other at all times while the piston 26 travels up and down within the cylinder 20. The gear rack 34 is engaged with the first freewheeling gearwheel 38 and the counterclockwise overrunning clutch 40. The first freewheeling gearwheel 38 and the counterclockwise overrunning clutch 40 are both mounted on the secondary driveshaft 42 as has been described above. The magnetic track 91 is driven electromagnetically by forcer 92. While the description shows magnetic track 91 attached to pushrod 28 and forcer 92 attached to engine block 32, it is evident that the two are interchangeable, and that forcer 92 can be attached to pushrod 28 and magnetic track 91 can be attached to engine block 32. It will be evident that in this embodiment, the gearwheel 46 and axle 48 and the second freewheeling gearwheel 52 and secondary driveshaft 54 are not required.

Going through a complete four stroke cycle and beginning at ATDC, the intake stroke starts when the EMS activates forcer 92, resulting in a downward movement of magnetic track 91, pushrod 28 and the piston 26. As soon as physical clearance allows, the EMS opens the intake valve 22, by means of hydraulic pressure or electric power. When DBDC is reached, the EMS closes the intake valve 22, ending the intake stroke.

The EMS then changes the direction of the electric field for forcer 92, resulting in a upward movement of magnetic track 91, pushrod 28 and piston 26, starting the compression stroke. This upward movement continues until DTDC is reached, thus ending the compression stroke. DTDC is determined by the EMS directly in an engine running in spark ignition mode or by the EMS sensing ignition through a cylinder-mounted pressure transducer in an engine running in HCCI-mode.

The power stroke begins when ignition occurs. When the EMS senses ignition, the EMS deactivates forcer 92. The EMS also activates fast-acting clutch 44, which engages and holds the first freewheeling gearwheel 38 in rotational lock with the secondary driveshaft 42 during the power stroke of the piston 26. Thus, as the piston is forced downward by the expanding gases, the energy released by the ignited charge is transferred to the secondary driveshaft 42 by the fast-acting clutch 44, by the counterclockwise overrunning clutch 40, or both. The piston 26 continues its downward movement until ABDC is reached, ending the power stroke.

At this time, the EMS opens up the exhaust valve 24, by means of hydraulic pressure or electric power, and deactivates the fast-acting clutch 44. The EMS also activates forcer 92, forcing magnetic track 91, pushrod 28 and piston 26 upwards and starting the exhaust stroke. As required, in order to provide physical clearance between the piston 26 and the exhaust valve 24, the valve 24 may be closed as the piston 26 approaches ATDC. When ATDC is reached, the EMS deactivates forcer 92 or optionally reduces electric power to a level which will hold piston 26 at rest at ATDC, thus completing the exhaust stroke and all four strokes of the standard Otto Cycle.

When introducing elements disclosed herein, the articles “a”, “an”, “the”, and “said” are intended to mean that there are one or more of the elements. The terms “comprising”, “having”, “including” are intended to be open-ended and mean that there may be additional elements other than the listed elements.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

What is claimed is:

1. A method for manipulating a piston within a cylinder of an internal combustion engine, the method comprising:
sensing dynamic top dead centre (DTDC) and dynamic bottom dead centre (DBDC); and
selectively engaging a first power transfer mechanism with the piston when DTDC is sensed and selectively disengaging the first power transfer mechanism from the piston when DBDC is sensed.

2. The method of claim 1, further comprising selectively disengaging a second power transfer mechanism with the piston when DTDC is sensed and selectively engaging the second power transfer mechanism from the piston when DBDC is sensed.

3. A method for operating a four stroke internal combustion engine, wherein the engine comprises a cylinder with a cylinder head, a piston, a pushrod, means for actuating the pushrod, a gear releasably coupled to a secondary driveshaft, and a transmission, the method comprising:
initiating intake stroke by actuating the pushrod downward, the cylinder taking in fuel during the intake stroke;
initiating compression stroke by actuating the pushrod upward, the piston compressing the fuel in the cylinder during the compression stroke;
initiating the expansion power stroke by igniting the fuel and engaging the gear with the secondary driveshaft, wherein the igniting causes the piston and pushrod to move downward and rotate the gear and secondary driveshaft, transmitting the energy generated during the expansion power stroke to the main engine driveshaft; and
initiating the exhaust stroke by actuating the pushrod upward, the cylinder releasing exhaust during the exhaust stroke.

4. The method of claim 3, wherein the igniting is caused by homogeneous charge compression ignition.

5. The method of claim 3, wherein the igniting is caused by a spark from a spark plug.

6. The method of claim 3, wherein the gear with the secondary driveshaft are releasably coupled by activating and deactivating a clutch.

7. The method of claim 6, wherein the engine comprises a second gear and a second secondary driveshaft that are releasably coupled by activating and deactivating a second clutch, and wherein the pushrod is actuated in one direction by activating the first clutch and is actuated in the other direction by activating the second clutch.

8. The method of claim 3, wherein the pushrod is actuated by a hydraulic fluid system.

9. The method of claim 3, wherein the pushrod is actuated by a motor.

10. The method of claim 9, wherein the motor is electric.

11. The method of claim 3, wherein the transmission comprises a first gear mounted on the secondary driveshaft and a second gear mounted on the main engine driveshaft, the first and second gears operably engaged, wherein rotation of the secondary driveshaft effects rotation of the main engine driveshaft.

12. A system for transferring power between a piston and a main driveshaft of an internal combustion engine comprising:
an ignition detector detecting compression ignition of combustible fuel in a combustion chamber associated with the piston; and
a selectively engagable first power transfer mechanism responsive to detection of ignition by the ignition detector to engage thereby to transfer power from the piston to the main driveshaft for a power stroke.

13. The system of claim 12, further comprising:
a position detector for detecting the position of the piston in the combustion chamber; and
a selectively engagable second power transfer mechanism responsive to the position detector to engage thereby to transfer power to the piston for a compression stroke or for an exhaust stroke;
wherein the first power transfer mechanism is disengaged while the second power transfer mechanism is engaged.

14. The system of claim 13, wherein the first power transfer mechanism is responsive to the position detector to engage thereby to transfer power to the piston for an intake stroke,
wherein the second power transfer mechanism is responsive to the position detector to disengage while the first power transfer mechanism is engaged.

15. The system of claim 13, wherein the second power transfer mechanism transfers power from the drive shaft.

16. The system of claim 13, wherein the second power transfer mechanism transfers power from a hydraulic pump.

17. The system of claim 13, wherein the second power transfer mechanism transfers power from an electric motor.

18. The system of claim 13, further comprising an electronic engine management unit operatively coupled to the ignition and position detectors that, in response to detection of ignition and/or position of the piston selectively engaging one or the other of the first and second power transfer mechanisms.

19. The system of claim 13, further comprising a selectively engagable braking mechanism responsive to the engine management unit for holding the piston at an absolute top dead center position, wherein the engine management unit selectively disengage the first and second power transfer mechanisms while the braking mechanism is engaged.
